(19) United States
(12) Patent Application Publication
(10) Pub. No.: US 2011/0151916 A1
(43) Pub. Date: Jun. 23, 2011

(54) APPARATUS AND METHOD FOR ALLEVIATION OF INITIAL CONNECTION DELAY

(75) Inventor: You Hee CHOI, Daejeon (KR)

(73) Assignee: Electronics and Telecommunications Research Institute, Daejeon (KR)

(21) Appl. No.: 12/878,867

(22) Filed: Sep. 9, 2010

(30) Foreign Application Priority Data
Dec. 21, 2009 (KR) 10-2009-0127720

(51) Int. Cl. H04B 7/00

(52) U.S. Cl. 455/518

(57) ABSTRACT

Disclosed are an apparatus and a method for alleviating an initial connection delay of PTT services. According to an aspect of the present invention, the apparatus for alleviating the initial connection delay of the PTT (Push-To-Talk) services includes: a delay time measuring device that measures delay time of a WiBro network using a timer when a mobile terminal is connected to the WiBro network; and a signal generator that generates PING signals to activate the network when the delay time exceeds the threshold time.

### CROSS-REFERENCE TO RELATED APPLICATIONS

This application claims priority under 35 U.S.C. 5119 to Korean Patent Application No. 10-2009-0127720, filed on Dec. 21, 2009, in the Korean Intellectual Property Office, the disclosure of which is incorporated herein by reference in its entirety.

### BACKGROUND OF THE INVENTION

1. Field of the Invention

The present invention relates to PTT services, and more particularly, to an apparatus and a method for alleviating an initial connection delay of PTT services that can stably receive the PTT services through a WiBro network based mobile terminal.

2. Description of the Related Art

Recently, integrated mobile terminals that integrate and support wireless networks, such as a mobile communication network, a WiFi, a WiBro, etc., are increasing. As a result, users are using mobile communication network based services and wireless IP network based services through integrated mobile terminals.

Industries using PTT services through the existing radiotelegraph, TRS, etc., demand the PTT services that use the IP-network based wireless terminals due to a problem in that available frequency is limited. That is, no delay should be generated at the time of transmitting voice when pressing the PTT buttons in order to provide PTT services. If a right to speak does not pass into other speakers, voices should be stably transmitted each time the PTT buttons are pressed.

The current WiBro network is unstable in terms of a network speed and has large deviation in a delay time, as compared to the wired networks. It is impossible to support the PTT services through a WiBro Network unless the problems are solved.

Today, services replacing the PTT services are urgently needed in industries. Therefore, an urgent need exists for a method capable of minimizing the initial connection delay of the PTT services by maximally alleviating the speed instability of the WiBro network.

### SUMMARY OF THE INVENTION

The present invention proposes to solve the above problems. It is an object of the present invention to provide an apparatus and a method for alleviating an initial connection delay of PTT (Push-to-talk) services and improve speed instability of a WiBro network.

It is another object of the present invention to provide an apparatus and a method for alleviating an initial connection delay of PTT services by transmitting and receiving dummy signals.

According to an aspect of the present invention, an apparatus for alleviating the initial connection delay of PTT (Push-to-talk) services, include: a delay time measuring device that measures delay time of a WiBro network using a timer when a mobile terminal is connected to the WiBro network; and a signal generator that generates PING signals to activate the network when the delay time exceeds the threshold time.

According to another aspect of the present invention, an apparatus for alleviating the initial connection delay of PTT (push-to-talk) services, includes: a service providing device that provides PTT services and WiBro services; a delay time measuring device that monitors the delay time of the network when a mobile terminal is connected to a WiBro network; and a signal generator that generates and transmits PING signals to alleviate the initial connection delay of each service when the delay time exceeds the threshold time.

According to another aspect of the present invention, a method for alleviating the initial connection delay of PTT (push-to-talk) services includes: measuring delay time of a WiBro network using a timer when a mobile terminal is connected to the WiBro network; generating dummy signals when the delay time exceeds the threshold time; and transmitting the dummy signals to activate the network.

According to the present invention, it can alleviate the initial connection delay of the PTT services by using the characteristics of the WiBro network that make the transmitting and receiving delay time long when not transmitting and receiving signals, such as the case of initially being connected to the WiBro network, etc., but are stabilized at an average speed when continuously transmitting and receiving signals.

In other words, the present invention maximally alleviates the speed instability of the WiBro network by transmitting and receiving the dummy signals to and from the terminal, thereby making it possible to minimize the initial connection delay of the PTT services.

### BRIEF DESCRIPTION OF THE DRAWINGS

FIG. 1 is a configuration diagram showing an apparatus for alleviating the initial connection delay of PTT services according to an exemplary embodiment of the present invention;

FIG. 2 is a configuration diagram showing an apparatus for alleviating the initial connection delay of PTT services according to another exemplary embodiment of the present invention; and

FIG. 3 is a flowchart showing a method for alleviating the initial connection delay of PTT services according to an exemplary embodiment of the present invention.

### DETAILED DESCRIPTION OF THE PREFERRED EMBODIMENTS

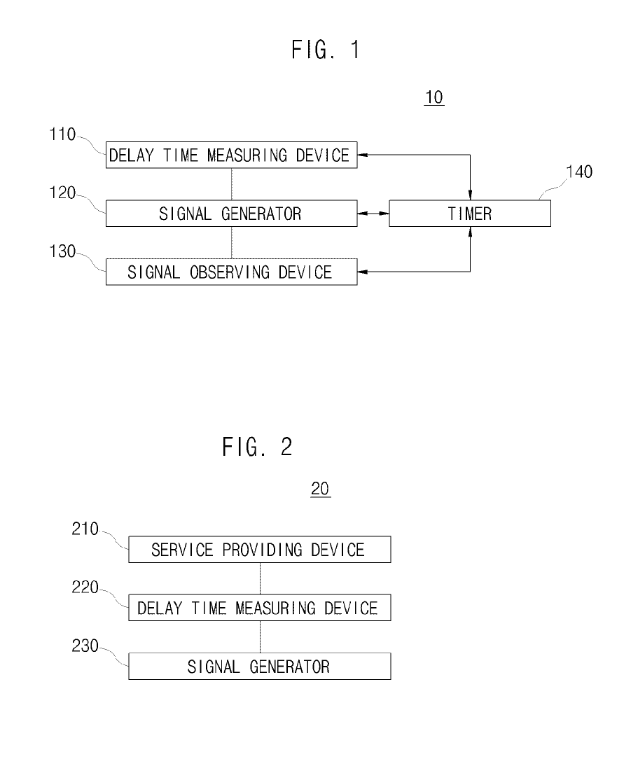

An apparatus for alleviating the initial connection delay of PTT services according to an exemplary embodiment of the present invention will now be described with reference to FIG. 1. FIG. 1 is a configuration diagram showing an apparatus for alleviating initial connection delay of PTT services according to an exemplary embodiment of the present invention.

As shown in FIG. 1, an apparatus 10 for alleviating initial connection delay of PTT services according to an exemplary embodiment of the present invention includes a delay time measuring device 110, a signal generator 120, and a signal observing device 130.

The delay time measuring device 110 measures the delay time of the network by using a timer 140 when a mobile terminal is booted and then, connected to the WiBro network.

In detail, the delay time measuring device 110 transmits SIP messages having no delay time other than the network delay time and measures the delay time consumed to receive the response message therefor.

The signal generator 120 generates and transmits PING signals to activate the network when the measured delay time is larger than the threshold time. At this time, the signal generator 120 continuously generates the PING signals until the delay time becomes the threshold time or less and initializes and stops the timer 140 when the generation of the PING signals stops.

The threshold time may be determined by the average delay time of the mobile terminal in the WiBro network.

The signal observing device 130 monitors whether continuously received signals exist in the WiBro network and if it is determined that there are continuously received signals, it requests stopping the generation of the PING signals to the signal generator 120 and initializes and stops the timer 140.

An apparatus for alleviating the initial connection delay of PTT services according to another exemplary embodiment of the present invention will now be described with reference to FIG. 2. FIG. 2 is a configuration diagram showing an apparatus for alleviating the initial connection delay of PTT services according to another exemplary embodiment of the present invention.

As shown in FIG. 2, an apparatus 20 for alleviating the initial connection delay of PTT services according to another exemplary embodiment of the present invention includes a service providing device 210, a delay time measuring device 220, and a signal generator 230.

The service providing device 210 receives the PTT services and the WiBro services through the WiBro network and provides them to the user.

The delay time measuring device 220 monitors the delay time of the WiBro network when the mobile terminal is connected to the WiBro network. The delay time measuring device 220 may measure the delay time using the timer by the time consumed to transmit an SIP request message and to receive the response messages therefor.

At this time, the delay time measuring device 220 may determine that the delay time exceeds the threshold time when the timer which is started when the mobile terminal is connected to the WiBro network is timed-out.

When the delay time exceeds the threshold time, the signal generator 230 generates and transmits the PING signals and alleviates the initial connection delay of each service. At this time, the signal generator 230 continuously generates the PING signals until the delay time is the threshold time or less.

If the signal generator 230 confirms that the continuously received signals exist in the WiBro network by itself or other devices, it may determine that there is no need to activate the network, so it does not generate the PING signals.

According to the present invention, it can alleviate the initial connection delay of the PTT services by using the characteristics of the WiBro network that make the transmitting and receiving delay time long when not transmitting and receiving signals, such as the case of initially being connected to the WiBro network, etc., but are stabilized at an average speed when continuously transmitting and receiving signals. In other words, the present invention maximally alleviates the speed instability of the WiBro network by transmitting and receiving the dummy signals to and from the terminal, thereby making it possible to minimize the initial connection delay of the PTT services.

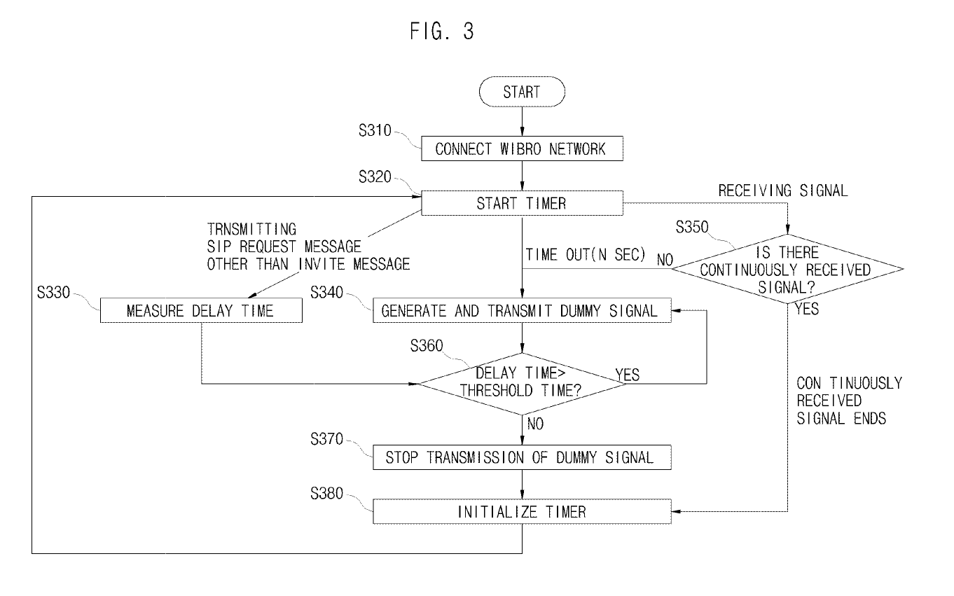

A method for alleviating the initial connection delay of PTT services according to an exemplary embodiment of the present invention will now be described with reference to FIG. 3. FIG. 3 is a flowchart showing a method for alleviating initial connection delay of PTT services according to another exemplary embodiment of the present invention.

Referring to FIG. 3, when the mobile terminal based on the WiBro network is on, the mobile terminal is connected to the WiBro Network (S310). And the apparatus 10 or 20 for alleviating the initial connection delay of the PTT services drives the timer (S320).

Next, the apparatus 10 or 20 for alleviating the initial connection delay of the PTT services transmits the SIP request message other than the Invite message until time-out is reached, and stops the timer.

And the apparatus 10 or 20 for alleviating the initial connection delay of the PTT services measures the delay time consumed to transmit and receive the response message (S330).

In addition, the apparatus 10 or 20 for alleviating the initial connection delay of the PTT services generates and transmits the PING signals to activate the WiBro network when the measured delay time is larger than the threshold time (S340).

Meanwhile, at the S320 stage, when time-out is reached, the apparatus 10 or 20 for alleviating the initial connection delay of the PTT services generates and transmits the PING signals to activate the WiBro network (S340).

At this time, the apparatus 10 or 20 for alleviating the initial connection delay of the PTT services continuously generates and transmits the PING signals until the delay time becomes less than the threshold time (S360). The apparatus 10 or 20 for alleviating the initial connection delay of the PTT services stops transmitting the PING signals when the measured delay time becomes the threshold time or less (S370), and initializes the timer (S380) and starts the timer (S320).

Herein, the threshold time may be determined by the average delay time consumed when the mobile terminal uses the services including the PTT services in the WiBro network.

In addition, the apparatus 10 or 20 for alleviating the initial connection delay of the PTT services monitors whether continuously received signals exist in the WiBro network (S350) and if it is determined that there are continuously received signals, it initializes the timer (S380) and starts the timer (S320).

Meanwhile, the apparatus 10 or 20 for alleviating the initial connection delay of the PTT services may repeatedly perform the processes of measuring the delay time as much as the predetermined number of times according to the predetermined period and generating the dummy signals when the mobile terminal does not use the services through the WiBro network, that is, the continuously transmitted and received signals do not exist in the WiBro network.

While configurations of certain embodiments have been described above with reference to the accompanying drawings, it is by way of example only. Those skilled in the art can make various modifications and changes within the technical spirit of the present invention. Accordingly, the actual technical protection scope of the present invention must be determined by the spirit of the appended claims.

What is claimed is:

1. An apparatus for alleviating an initial connection delay of push-to-talk (PTT) services, comprising:
a delay time measuring device that measures delay time of a WiBro network using a timer when a mobile terminal is connected to the WiBro network; and
a signal generator that generates PING signals to activate the network when the delay time exceeds threshold time.

2. The apparatus for alleviating the initial connection delay of the PTT services according to claim 1, further comprising a signal observing device that monitors whether continuously received signals exist in the WiBro network.

3. The apparatus for alleviating the initial connection delay of the PTT services according to claim 2, wherein when there are continuously received signals, the signal observing device stops generation of the PING signal of the signal generator and initializes and stops the timer.

4. The apparatus for alleviating the initial connection delay of the PTT services according to claim 1, wherein the signal generator continuously generates the PING signals until the delay time is the threshold time or less.

5. The apparatus for alleviating the initial connection delay of the PTT services according to claim 4, wherein the signal generator initializes and stops the timer when the generation of the PING signals stops.

6. The apparatus for alleviating the initial connection delay of the PTT services according to claim 1, wherein the delay time measuring device measures the delay time by the time consumed to transmit SIP request messages and to receive the response messages therefor.

7. The apparatus for alleviating the initial connection delay of the PTT services according to claim 1, wherein the threshold time is determined by an average delay time of the mobile terminal in the network.

8. An apparatus for alleviating the initial connection delay of PTT services, comprising:
a service providing device that provides post-to-talk (PTT) services and WiBro services;
a delay time measuring device that monitors the delay time of the network when a mobile terminal is connected to a WiBro network; and
a signal generator that generates and transmits PING signals to alleviate the initial connection delay of each service when the delay time exceeds threshold time.

9. The apparatus for alleviating the initial connection delay of the PTT services according to claim 8, wherein the delay time measuring device confirms the delay time by the time consumed to transmits the SIP request messages and to receive the response messages therefor.

10. The apparatus for alleviating the initial connection delay of the PTT services according to claim 8, wherein the signal generator does not generate the PING signals when the continuously received signals exist in the WiBro network.

11. The apparatus for alleviating the initial connection delay of the PTT services according to claim 10, wherein the threshold time is determined by an average delay time according to the transmission and reception of the continuously received signals.

12. The apparatus for alleviating the initial connection delay of the PTT services according to claim 8, wherein the signal generator continuously generates the PING signals until the delay time is the threshold time or less.

13. The apparatus for alleviating the initial connection delay of the PTT services according to claim 8, wherein the delay time measuring device determines that the delay time exceeds the threshold time when the timer is timed-out.

14. A method for alleviating the initial connection delay of PTT (push-to-talk) services, comprising:
measuring delay time of a WiBro network using a timer when a mobile terminal is connected to the WiBro network;
generating dummy signals when the delay time exceeds threshold time; and
transmitting the dummy signals to activate the network.

15. The method for alleviating the initial connection delay of the PTT services according to claim 14, wherein the measuring includes:
transmitting SIP request messages to the network;
receiving response messages from the network; and
measuring the delay time consumed for the transmission and reception using the timer.

16. The method for alleviating the initial connection delay of the PTT services according to claim 14, wherein the threshold time is determined by the average delay time of the mobile terminal in the network.

17. The method for alleviating the initial connection delay of the PTT services according to claim 14, wherein the measuring to the activating are repeatedly performed as much as the predetermined number of times according to the predetermined period when the signals transmitted and received to and from the network do not continuously exist.

18. The method for alleviating the initial connection delay of the PTT services according to claim 14, further comprising:
monitoring whether continuously received signals exist in the network; and
not generating the dummy signals when there are the continuously received signals.

19. The method for alleviating the initial connection delay of the PTT services according to claim 14, wherein the generating and the activating include stopping the generation of the dummy signals when the delay time is the threshold time or less.

20. The method for alleviating the initial connection delay of the PTT services according to claim 19, wherein the stopping includes initializing and stopping the timer.
